(19) United States
(12) Patent Application Publication
(10) Pub. No.: US 2004/0249983 A1
(43) Pub. Date: Dec. 9, 2004

(54) Method and system for accessing a web page within a network

(76) Inventor: Ilja Bedner, Palo Alto, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/394,600

(22) Filed: Mar. 21, 2003

(51) Int. Cl. G06F 15/16

(52) U.S. Cl. 709/249

(57) ABSTRACT

The present invention includes a method and system for accessing a web page within a network. According to the present invention, a method and system is provided for accessing a web page wherein the web page is invoked based on the receipt of a beacon. Through the use of the method and system in accordance with the present invention, a web surfer has the ability to quickly and automatically access a web page without having to know the specific uniform resource identifier of the web page. The method and system include receiving a beacon packet wherein the beacon packet contains session identification information, connecting to the network and invoking the web page based on the session identification information.

### FIELD OF THE INVENTION

The present invention relates to the field of computer networks, and more particularly to a method and system for accessing a web page within a network.

### BACKGROUND OF THE INVENTION

Wireless networks, such as Local Area Networks (LANs), are intended to offer flexible and cost-effective alternatives to wired networks. An advantage of wireless networks over fixed networks is the ease with which new networks can be created and the ease with which new devices (wireless terminals) can be added to the network. Some wireless network standards exist, for example IEEE 802.11 in the USA and HIPERLAN in Europe, while others are under development, for example Wireless Asynchronous Transfer Mode (WATM). Such standards define the format of a transmission frame, within which control and data transfer functions can take place.

Networks including wireless mobile terminals now serve to help automate and expedite processes in retail, manufacturing, warehousing and other industries. In a retail environment, wireless mobile terminals may take the form of a wireless bar code reading device for use in tracking inventory and checking prices.

In order to provide for real time communication, the mobile terminals often include a radio which allows the radio to communicate, for example, with a host computer connected to a LAN. LANs allow devices operating in a building or specified site to be connected. Devices physically connected to the LAN may include desk top computers, printers and host computers. If the LAN also supports wireless mobile terminals such as those mentioned above, the LAN will also have connected thereto one or more access points (sometimes referred to as base stations). Each access point is coupled to the LAN and includes at least one radio through which wireless communication with the mobile terminals can occur.

Each access point can communicate with mobile terminals operating within the cell coverage area of the access point and allow users to connect to a network such as the Internet. The cell coverage area is the area in which the access point can reliably communicate with a mobile terminal. Once the mobile terminal roams outside of the cell coverage area of the access point, the mobile terminal can no longer communicate with the LAN through that particular access point. In order to provide cell coverage throughout an entire building or site, a LAN typically includes multiple access points strategically located throughout the building or site. Thus, the combined cell coverage of the access points is sufficient to cover the entire building or site. Mobile terminals may then roam from one area to another within the LAN.

Many public establishments such as coffee shops and libraries utilize wireless access points to provide patrons with a way access networks such as the Internet. For example, if a patron walks into a Starbucks® coffee shop, the patron can utilize a device such as a laptop computer or a personal digital assistant to access the Internet.

In many cases, each public establishment has an associated web page that contains information regarding the establishment that could be of potential use to the patron. For example, a retail store may have a web page that describes the merchandise it offers, store hours, special savings offers, etc. However, for a patron to find the right web page of the public establishment, the patron either has to memorize the web address of the web page or has to find the web page through searching and browsing the Internet. This is extremely burdensome for the patron.

Accordingly, what is needed is a method and system that provides a patron with access to a web page associated with a public establishment without the patron having to memorize the web address of the web page. The method and system should be simple, cost effective and capable of being easily adapted to existing technology. The present invention addresses these needs.

### SUMMARY OF THE INVENTION

The present invention includes a method and system of accessing a web page within a network. According to the present invention, a method and system is provided for accessing a web page wherein the web page is invoked based on the receipt of a beacon. Through the use of the method and system in accordance with the present invention, a web surfer has the ability to quickly and automatically access a web page without having to know the specific uniform resource identifier of the web page.

A first aspect of the present invention includes a method of accessing a web page within a network. The method includes receiving a beacon packet wherein the beacon packet contains session identification information, connecting to the network and invoking the web page based on the session identification information.

Another aspect of the present invention includes a beacon transmission system. The beacon transmission system includes a beacon transmitter for transmitting a beacon packet wherein the beacon packet includes an SSID and a device capable of receiving the beacon packet, wherein the device includes means for connecting to a network and means for accessing a web page within the network based on the SSID.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a high-level flow chart of a method for accessing a web page in a network in accordance with an embodiment of the present invention.

FIG. 2 is an exemplary system for accessing a web page in a network in accordance with an embodiment of the present invention.

FIG. 3 shows a block diagram of an example of hardware that could be included in a web accessing device in accordance to an embodiment of the present invention.

FIG. 4 shows a non-exhaustive list of relay interfaces, which may be included in the web accessing device in accordance with an embodiment of the present invention.

FIG. 5 shows a non-exhaustive list of I/O devices, which may be included in the web accessing device in accordance with an embodiment of the present invention.

FIG. 6 shows an example of a beacon receiver in accordance with an embodiment of the present invention.

FIG. 7 is a flow chart of a method in accordance with an alternate embodiment of the present invention.

### DETAILED DESCRIPTION

The present invention relates to a method and system for accessing a web page within a network. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

While the invention will be described in the general context of an application program that runs on an operating system and in connection with a server, those skilled in the art will recognize that the invention also may be implemented in combination with other program modules. Generally, program modules include routines, operating systems, application programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like.

The present invention includes a method and system of accessing a web page within a network. According to the present invention, a method and system is provided for accessing a web page wherein the web page is invoked based on the receipt of a beacon. Through the use of the method and system in accordance with the present invention, a web surfer has the ability to quickly and automatically access a web page without having to know the specific uniform resource identifier (URI) of the web page. One of ordinary skill will readily recognize that a URI could be a Uniform Resource Locator (URL) as well.

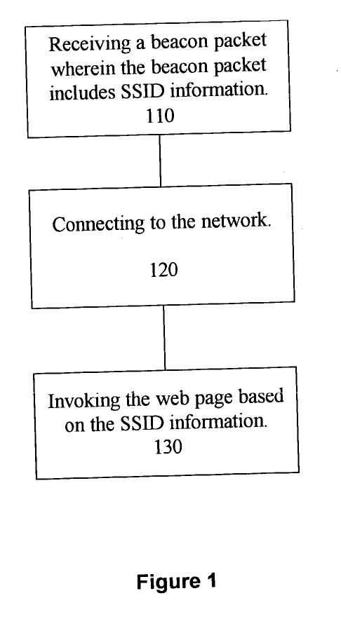

For a further understanding of the present invention, please refer now to FIG. 1. FIG. 1 is a flowchart of a method in accordance with an embodiment of the present invention. A first step 110 includes receiving a beacon packet wherein the beacon packet includes session identification (SSID) information. The next step 120 includes connecting to a network. In an embodiment the network is the Internet. The final step 130 includes automatically invoking a web page based on the SSID information. In an embodiment, the SSID includes a specific URI and a web page associated with the URI is invoked. Because the web page is invoked automatically, a web surfer does not have to know the specific URI to access the web page.

The invention may also be practiced in distributed computing environments where tasks are performed by remote processing devices that are linked through a communications network. In a distributed computing environment, program modules may be located in both local and remote memory storage devices. Execution of the program modules may occur locally in a stand-alone manner or remotely in a client/server manner. Examples of such distributed computing environments include local area networks of an office, enterprise-wide computer networks, and the Internet.

The Internet, which is a global web of interconnected computers and computer networks, integrates local area networks (LANs) located in various entities, such as businesses, libraries, federal agencies, institutes of learning, and research organizations into a single communication network. The Internet uses a common communication protocol suite, known as a Transmission Control Protocol/Internet Protocol (TCP/IP), which was specifically designed for the interconnection of different computer systems. Internal and external networks are linked by routers that route data packets from a sending network to another router or a receiving network. Gateways handle data transfer and conversion of messages from a sending network to the protocols used by a receiving network. Typically, gateways refer to devices that translate between applications. For example, e-mail gateways translate messages from one vendor's messaging program to another vendor's messaging program so that users with different e-mail programs can share messages over a network.

Typically, the computers connected to a wide area network such as the Internet are in identified as either servers or clients. A server is a computer that stores files that are available to the other computers connected to the network. For example, an e-mail server manages message traffic and mail boxes for users, in addition to translation facilities or gateways that allow message exchange between different types of e-mail programs. A client is a computer connected to the network that accesses shared resources provided by a server. To obtain information from a server, a client makes a request for a file or information located on the server using a specified protocol. Upon reception of a properly formatted request, the server downloads the file or information to a local message store located at the client.

As previously mentioned, wireless networks have become increasingly popular. A wireless network is a local area network that transmits over the air typically in an unlicensed frequency such as the 2.4 GHz band. A wireless network does not require lining up devices for line of sight transmission. Wireless access points (base stations) are connected to an Ethernet hub or server and transmit a radio frequency over an area of several hundred to a thousand feet which can penetrate walls and other non-metal barriers. Roaming users can be handed off from one access point to another like a cellular phone system. Laptops, personal digital assistants (PDAs) and other wireless devices use wireless modems that plug into an existing Ethernet port or that are self-contained on PC cards.

The physical world is comprised of physical entities. The physical entity can be a place such as a coffee shop, a bookstore, a museum, a conference room or a hotel room. The physical entity can also be a car displayed in a showroom or a bus terminal or stop. Within the virtual world (i.e. the Internet), each physical entity can have one or more 111 associated web pages. For example, each Starbucks coffee shop may have a home page associated with it that contains written text, audio, and/or images to describe it. Additionally, if the physical entity is a car, then the web page can list all of the features of the car along with any other relevant information. Moreover, 2-D or 3-D structures may be included to illustrate the internal components of the car along with video programs about the car.

As a further example, if the physical entity is a bus stop, the web page can contain and display various bus arrival and departure schedules of the particular bus stop. However, for a person to access the correct web page, a web surfer has to memorize the URI of the web page or has to utilize a search engine to search the network. This causes difficulty and inconvenience for the user to access the particular web page. The present invention makes it possible to access these web pages without the user having to know the URI of the web page.

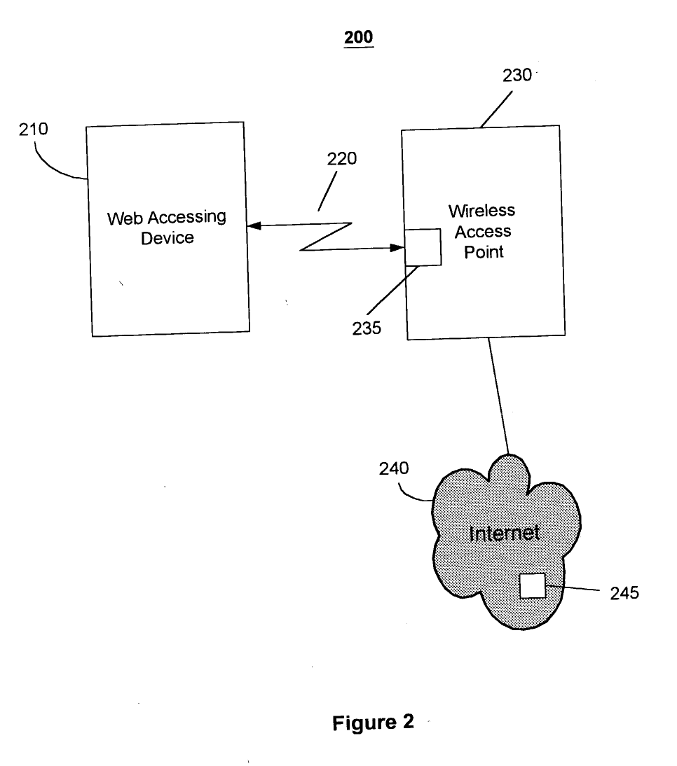

FIG. 2 shows an exemplary system 200 in accordance with an embodiment of the present invention. The system 200 includes a web accessing device 210 capable of being coupled to a wireless access point 230 via a wireless link 220. Wireless access point 240 includes a beacon transmitter 235 and is coupled to the Internet 240 wherein the Internet contains a plurality of web pages 245.

In an embodiment, the web accessing device 210 can be a portable or mobile electronic device such as a laptop computer, a PDA, a mobile phone or the like with wired or wireless Internet access. Alternatively, the web accessing device 230 can be any kind of information appliance, or any kind of portable handheld electronic device or appliance, which may have limited processing, storage, and display resources. Moreover, one of ordinary skill in the art will readily recognize that a variety of devices could be utilized in conjunction with the various embodiments of the present invention while remaining within the spirit and scope of the present invention.

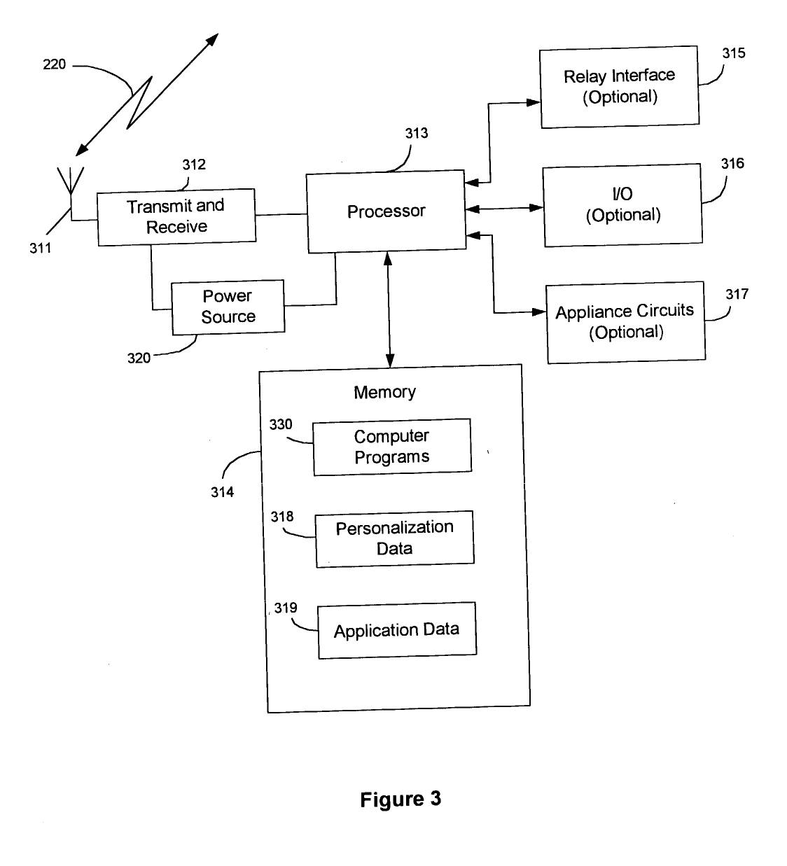

FIG. 3 shows a block diagram of hardware that could be included in the web accessing device 210 in accordance with the present invention. The web accessing device 210 includes an antenna 311 configured to support wireless communication link 220. Antenna 311 couples to a transmit and receive section 312. Transmit and receive section 312 is compatible with the protocols that the web accessing device 210 uses to communicate with the wireless access point 230. An adjustable power source 320 couples to transmit and receive section 312 and to a processor 313. Processor 313 couples to a memory 314, an optional relay interface 315, an optional I/O section 316, and optional appliance circuits 317.

Processor 313 executes computer programs 330 which are stored in memory 314. Computer programs 330 define processes performed by processor 313. Processor 313 is capable of adjusting the power being supplied by the power source 320 to the transmit and receive section 312. By adjusting the power the supplied to the transmit and receive section 312, the processor 313 controls the communication range of the wireless link 220.

Additionally, memory 314 can store personalization data 318 and application data 319. Personalization data 318 characterize a user or owner of the web accessing device 210 and may change from user to user. ID codes, passwords, and PINs are examples of personalization data 318 as are radio or TV channel presets, language preferences, and speed dial telephone numbers. Application data 319 is provided by performing peer applications, and may change from moment to moment.

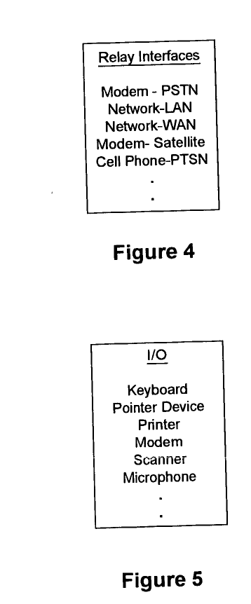

FIG. 4 shows a non-exhaustive list of relay interfaces 315 which may be included in the web accessing device 210. Referring to FIGS. 3 and 4, relay interfaces 315 may be configured as any of a wide variety of relay, routing, or gateway devices known to those skilled in the art. For example, the relay interfaces 315 may couple the web accessing device 210 to LANs or WANs. For example, web browser can be utilized to access the Internet. A web browser is a program that serves as a front end to the World Wide Web on the Internet. In order to view a web page, the web page address (URI) is typed into the browser's Location field.

FIG. 5 shows a non-exhaustive list of I/O devices 316 which may be included in the web accessing device 210. Referring to FIGS. 3 and 5, I/O devices 316 may be classified into input devices and output devices. Input devices may include keyboards, pointing devices, optical scanners, microphones, and other well-known input devices. Output devices may include printers, monitors, speakers, and other well-known output devices.

Those skilled in the art will readily appreciate that relay interface section 315, I/O section 316 and appliance circuits 317 are not mutually exclusive categories. For example, many devices fall into multiple categories. For example, a computer considered as an appliance may include both an I/O section and a relay interface. Likewise, a relay interface may serve an I/O role.

Referring back to FIG. 2, the wireless access point 230 includes a beacon transmitter 235 (or beacon). The term “beacon” is defined as an electronic device that can perform two major functions. One is to store or contain session identification (SSID) information and the other is to transmit electrical signals embedding the stored or contained information. In an embodiment, the SSID information includes a URI of a web page.

In an embodiment, the beacon 235 broadcasts or transmits the SSID information containing the URI of a web page based on a predetermined open standard communication protocol. In an embodiment) the beacon 235 constantly transmits signals. In an alternate embodiment, the beacon 235 transmits the signal periodically.

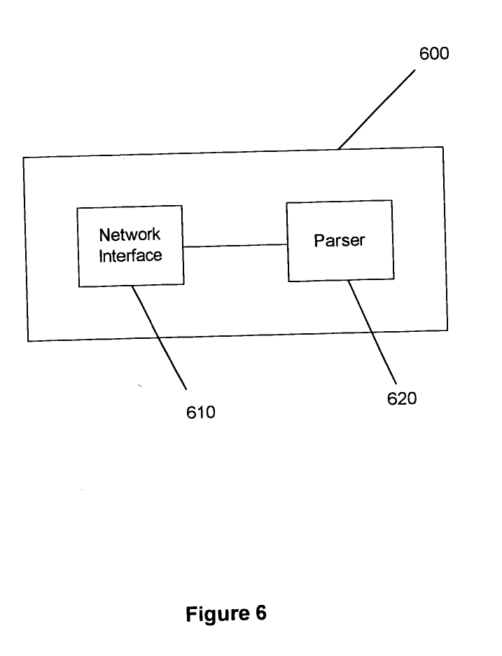

Referring to FIG. 3, in an embodiment, the transmit and receive section 312 can include a beacon receiver. The beacon receiver receives the beacon signal from the beacon 235. For an example of a beacon receiver, please refer to FIG. 6. FIG. 6 shows an example of a beacon receiver 600 in accordance with an embodiment of the present invention. The beacon receiver 600 can include a network interface 610 and a beacon parser 620. In an embodiment, the network interface 610 receives a beacon string (i.e. beacon signals that contain the SSID) from the wireless access point 235 (see FIG. 2).

The structure and operation of the network interface 610 depends on the communication technology used by the wireless access point 235. For example, if the wireless access point utilizes radio frequency technology to transmit the beacon string, then the network interface 610 is set to receive radio frequency signals. If the wireless access point 235 utilizes infrared transmission technology, then the network interface 610 is an infrared network interface.

The network interface 610 also includes a context manager (not shown). The context manager can be an application that collects the beacon strings that are being received by the beacon receiver 600. In an embodiment, the context manager bookmarks a beacon string for as long as the beacon receiver 600 receiver the beacon signals for the beacon string. When the beacon is no longer heard by the beacon receiver 600, the beacon string can be removed from the list based on application use policy.

In an embodiment, the beacon parser 620 is utilized to separate different data from the beacon string received from the wireless access point 235. As is described above, the beacon string may include more than just the SSID information. It may include information regarding whether the web address is presented in the hypertext form, and if so, the user name of the hypertext. That being the case, the beacon parser 620 is utilized to separate the beacon string into different data fields.

The transmission range of the beacon 235 is determined by the physical network communication technology adopted by the beacon 235. In an embodiment, the network communication technology employed by the beacon 235 can be a short or long range wireless technology. An example of a wireless transmission protocol is the IEEE 802.11 or WiFi protocol. The 802.11 protocol is a family of IEEE standards for wireless LANs first introduced in 1997. The first standard was 802.11b, which specifies from 1 to 11 Mbps in the unlicensed 2.4 GHz band using direct sequence spread spectrum (DSSS) technology. Using the orthogonal FDM (OFDM) transmission method, there are two subsequent standards that provide from 6 to 54 Mbps: 802.11a transmits in the higher 5 GHz frequency range and is not backward compatible with the slower 802.11b, 802.11g works in the same range and is compatible.

An 802.11 system works in two modes. In “infrastructure mode,” wireless devices communicate to a wired LAN via access points. Each access point and its wireless devices are known as a Basic Service Set (BSS). An Extended Service Set (ESS) is two or more BSSs in the same subnet. In “ad hoc mode,” also known as “peer-to-peer mode,” wireless devices can communicate with each other directly and do not use an access point. This is an Independent BSS (IBSS). The speed of 802.11 systems is distance dependent. The farther away the remote device from the base station, the lower the speed.

Additionally in accordance with an embodiment of the present invention, the communication link 220 (see FIG. 2) is a radio link in accordance with the Bluetooth Global Specification for wireless connectivity. Bluetooth is an open standard for short-range transmission of digital voice and data between mobile devices (laptops, PDAs, phones) and desktop devices. It supports point-to-point and multipoint applications. Unlike Infra-Red, which requires that devices be aimed at each other (line of sight), Bluetooth uses omni-directional radio waves that can transmit through walls and other non-metal barriers. Bluetooth transmits in the unlicensed 2.4 GHz band and uses a frequency hopping spread spectrum technique that changes its signal 1600 times per second. If there is interference from other devices, the transmission does not stop, but its speed is downgraded.

The Bluetooth baseband protocol is a combination of circuit and packet switching. Each data packet is transmitted in a different hop frequency wherein the maximum frequency hopping rate is 1600 hops/s. Bluetooth can support an asynchronous data channel, up to three simultaneous synchronous voice channels, or a channel, which simultaneously supports asynchronous data and synchronous voice. Each voice channel supports 64 kb/s synchronous (voice) link. The asynchronous channel can support a symmetric link of maximally 721 kb/s in either direction while permitting 57.6 kb/s in the return direction, or a 432.6 kb/s symmetric link.

The above-described embodiments of the invention may also be implemented, for example, by operating a computer system to execute a sequence of machine-readable instructions. The instructions may reside in various types of computer readable media. In this respect, an alternate embodiment of the present invention concerns a programmed product, comprising computer readable media tangibly embodying a program of machine readable instructions executable by a digital data processor to perform the method in accordance with an embodiment of the present invention.

This computer readable media may comprise, for example, RAM (not shown) contained within the system. Alternatively, the instructions may be contained in another computer readable media such as a magnetic data storage diskette and directly or indirectly accessed by the computer system. Whether contained in the computer system or elsewhere, the instructions may be stored on a variety of machine readable storage media, such as a DASD storage (e.g. a conventional “hard drive” or a RAID array), magnetic tape, electronic read-only memory, an optical storage device (e.g., CD ROM, WORM, DVD, digital optical tape), paper “punch” cards, or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

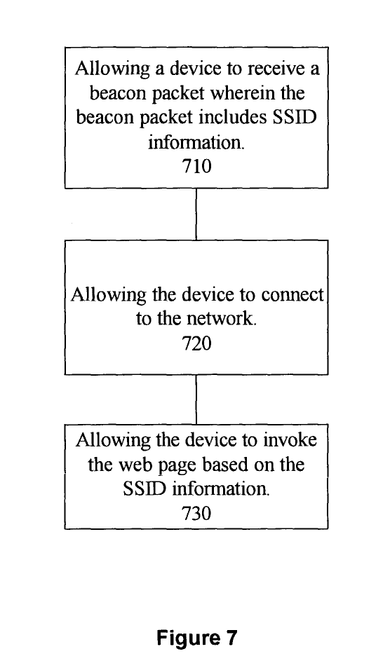

For a better understanding of the above-described alternate embodiment of the present invention, please refer to FIG. 7. FIG. 7 is a flowchart of program instructions that could be contained within a computer readable medium in accordance with the alternate embodiment of the present invention. A first step 7 1 0 involves allowing a beacon packet to be received by a web-accessing device wherein the beacon packet includes session identification (SSID) information. The next step 720 includes allowing the web accessing device to connect to a network. In an embodiment the network is the Internet. A final step 730 includes allowing a web page to automatically invoked based on the SSID information. In an embodiment, the SSII) includes a specific URI and a web page associated with the URI is invoked. Because the web page is invoked automatically, a web surfer does not have to know the specific URI to access the web page.

A method and system of accessing a web page within a network has been disclosed. According to the present invention, a method and system is provided for accessing a web page wherein the web page is invoked based on the receipt of a beacon. Through the use of the method and system in accordance with the present invention, a web surfer has the ability to quickly and automatically access a web page without having to know the specific uniform resource identifier of the web page.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method of accessing a web page within a network comprising:
receiving a beacon packet wherein the beacon packet contains session identification (SSID) information;
connecting to the network; and
automatically invoking the web page based on the SSID information.

2. The method of claim 1 wherein the web page comprises a uniform resource identifier (URI) and the SSID includes the URI.

3. The method of claim 2 wherein invoking the web page based on the SSID further comprises,
determining whether the SSID includes the URI; and
invoking the web page if the SSID includes the URI.

4. The method of claim 3 wherein the web page is invoked via a web browser.

5. The method of claim 3 wherein the web page is invoked via a shell command.

6. The method of claim 3 wherein the URI comprises a uniform resource locator.

7. The method of claim 3 wherein the network comprises the Internet.

8. A system for accessing a web page within a network comprising:
means for receiving a beacon packet wherein the beacon packet contains session identification (SSID) information;
means for connecting to the network; and
means for invoking the web page based on the SSID information.

9. The system of claim 8 wherein the web page comprises a uniform resource identifier (URI) and the SSID includes the URI.

10. The system of claim 9 wherein the means for invoking the web page based on the SSID further comprises:
means for determining whether the SSID includes the URI; and
means for invoking the web page if the SSID includes the URI.

11. The system of claim 10 wherein the means for invoking the web page comprises a web browser.

12. The system of claim 10 wherein the means for invoking the web page comprises means for invoking the web page via a shell command.

13. The system of claim 10 wherein the URI comprises a uniform resource locator.

14. The system of claim 10 wherein the network comprises the Internet.

15. A computer readable medium containing program instructions for accessing a web page within a network, the program instructions comprising:
allowing a device to receive a beacon packet wherein the beacon packet contains session identification (SSID) information;
allowing the device to connect to the network; and
allowing the device to invoke the web page based on the SSID information.

16. The computer readable medium of claim 15 wherein the web page comprises a uniform resource identifier (URI) and the SSID includes the URI.

17. The computer readable medium of claim 16 wherein invoking the web page based on the SSID further comprises:
determining whether the SSID includes the URI; and
invoking the web page if the SSID includes the URI

18. A beacon transmission system comprising:
a beacon transmitter for transmitting a beacon packet wherein the beacon packet includes an SSID; and
a device capable of receiving the beacon packet, wherein the device comprises
means for connecting to a network; and
means for accessing a web page within the network based on the SSID.

19. The beacon transmission system of claim 18 wherein the web page comprises a uniform resource identifier (URI) and the SSID includes the URI.

20. The beacon transmission system of claim 19 wherein the means for invoking the web page based on the SSID further comprises:
means for determining whether the SSID includes the UTRI; and
means for invoking the web page if the SSID includes the URI.

21. The beacon transmission system of claim 20 wherein the device comprises a personal digital assistant.

22. The beacon transmission system of claim 20 wherein the device comprises a laptop computer system.

23. The beacon transmission system of claim 22 wherein the beacon transmitter comprises a wireless access point and the device is capable of receiving the beacon packet via a wireless communication link.

24. The beacon transmission system of claim 22 wherein the wireless communication link comprises a WIFI link.

25. The beacon transmission system of claim 22 wherein the wireless communication link comprises a Bluetooth link.

26. The beacon transmission system of claim 22 wherein the network comprises the Internet.
